(19) United States
(12) Patent Application Publication
(10) Pub. No.: US 2007/0248064 A1
(43) Pub. Date: Oct. 25, 2007

(54) METHOD AND APPARATUS FOR SUPPORTING ROUTING AREA UPDATE PROCEDURES IN A LONG TERM EVOLUTION GENERAL PACKET RADIO SERVICE TUNNELING PROTOCOL-BASED SYSTEM

(75) Inventor: Kamel M. Shaheen, King of Prussia, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/735,560

(22) Filed: Apr. 16, 2007

Related U.S. Application Data
(60) Provisional application No. 60/793,289, filed on Apr. 19, 2006.

(51) Int. Cl. H04Q 7/24

(52) U.S. Cl. 370/338

(57) ABSTRACT

A method and apparatus for supporting routing area (RA) update in a long term evolution (LTE) general packet radio service (GPRS) tunneling protocol (GTP)-based system are disclosed. A wireless transmit/receive unit (WTRU) sends an RA update request to a new evolved Node-B (eNodeB) and a mobility management entity (MME). The MME sends an update packet data protocol (PDP) context request to an access gateway (AGW), whereby a new tunnel is established between the new eNodeB and the AGW. For an inter-MME routing area update, the WTRU sends an RA update request to a new eNodeB and a new MME. The new MME sends an MME context request to an AGW. The AGW sends an MME context response to the new MME. The new MME sends an update PDP context request to the AGW, whereby a new tunnel is established between the new eNodeB and the AGW.

### CROSS REFERENCE TO RELATED APPLICATIONS

This application claims the benefit of U.S. Provisional Application No. 60/793,289 filed Apr. 19, 2006, which is incorporated by reference as if fully set forth.

### FIELD OF INVENTION

The present invention is related to a wireless communication system. More particularly, the present invention is related to a method and apparatus for supporting routing area update (RAU) in a long term evolution (LTE) general packet radio service (GPRS) tunneling protocol (GTP)-based system.

### BACKGROUND

FIG. 1 shows a conventional GPRS/third generation (3G) wireless communication system architecture 100 that shows various interfaces/protocols as well as user data transfer interfaces between various network entities. The wireless communication system 100 includes at least one serving GPRS support node (SGSN) 105 and at least one gateway GPRS support node (GGSN) 110. The wireless communication system 100 further comprises a universal terrestrial radio access network (UTRAN) 115 which includes one or more radio access networks (RANs), base station systems (BSSs) and radio network controllers (RNCs), (not shown). The system 100 also comprises a plurality of wireless transmit/receive units (WTRUs) 120, each including a terminal equipment (TE) 125 coupled to a mobile terminal (MT) 130. The mobility in the wireless communication system 100 is facilitated by anchoring an Internet Protocol (IP) session at the GGSN 110 and allowing for multi-level mobility by supporting mobility management (MM) protocols for IP and non-IP traffic/services provided by the SGSN 105.

FIG. 2A shows how dual tunnels are established in the conventional wireless communication system 100 of FIG. 1 to provide IP connectivity for user plane traffic. As shown in FIG. 2A, a GPRS tunnelling protocol (GTP) user plane (GTP-U) tunnel 220 is established between a GGSN 205 and an SGSN 210, and a second user plane tunnel 225 is established between the SGSN 210 and a radio network controller (RNC) 215. Both tunnels are dedicated to the same user. The GTP tunnel 220 has a user plane and a control plane. The user tunnel 225 is an IP tunnel having a user plane and a RAN application part (RANAP) control plane used for control messaging.

FIG. 3 shows the system architecture evolution (SAE) of a long term evolution (LTE)-based network with various interfaces/protocols as well as user data transfer interfaces between various network entities. The wireless communication system 300 includes an evolved packet core 305 comprising at least one mobility management entity (MME)/user plane entity (UPE) 310 and at least one inter-access system (AS) anchor 315, also called an access gateway (AGW). An evolved radio access network 320 includes at least one evolved Node-B (eNodeB). The wireless communication system 300 further comprises a GPRS core 325 as described above with reference to FIG. 1, which includes at least one universal terrestrial radio access network (UTRAN) 330, and at least one GPRS enhanced data rates for global system for mobile communications (GSM) evolution (EDGE) radio access network (GERAN) 335. Mobility of WTRUs (not shown) in the wireless communication system 300 is facilitated by anchoring Internet Protocol (IP) sessions at the AGW 315 and allowing for multi-level mobility by supporting mobility management (MM) protocols for IP traffic/services provided by the AGW 315.

LTE based networks are the evolution toward all IP Networks (AIPNs). IP traffic generated from the network operator, such as instant messaging, and non third generation partnership project (3GPP) IP traffic, (i.e., wireless local area network (WLAN) traffic), is anchored and routed through the AGW 315.

A routing area update (RAU) is used to minimize the paging traffic within a wireless communication system that is grouped into clusters. Each cluster includes a group of cells (Node-Bs). Each cluster is defined by a unique identifier, (i.e., routing area identifier (ID)). Those WTRUs in the wireless communication system that travel across boundaries of the clusters have to perform a registration process called a routing area update. In the RAU, the WTRU informs the core network regarding which area of the system it is operating in. If the WTRU receives a terminated call, the core network pages the WTRU in the last known routing area. This eliminates the need to send a paging message for the WTRU throughout the entire system, which in turn significantly reduces the amount of signalling across the system. Thus, more processing power is allocated to user traffic. The RAU may require the establishment of a new connection between a GGSN and a new RNC. New processes and message formats are needed for a single tunnel approach as compared to those existing in a two tunnel approach.

One objective in LTE is to facilitate mobility and reducing development cost by anchoring IP sessions at the access gateway (AGW) and allowing for multi-level mobility and supporting existing GPRS/3G mobility management (MM) protocols. In LTE, most of the services and applications are migrating toward IP-based platforms. This migration requires IP connectivity and the traffic generated does not have be terminated at a mobility management entity (MME)/user plane entity (UPE), as it is the case in GPRS.

### SUMMARY

The present invention is related to a method and apparatus for supporting routing area update in an LTE GTP-based system. In accordance with the present invention, a single GTP tunnel is established between an AGW and an eNodeB. A WTRU sends a routing area update request to a new eNodeB, which forwards the routing area update request to an MME. The MME sends an update packet data protocol (PDP) context request to an AGW, whereby a new tunnel is established between the new eNodeB and the AGW. For an inter-MME routing area update, the WTRU sends a routing area update request to a new eNodeB, which forwards the routing area update request to a new MME. The new MME sends an MME context request to an AGW. The AGW sends an MME context response to the new MME. The new MME sends an update PDP context request to the AGW, whereby a new tunnel is established between the new eNodeB and the AGW.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 shows a conventional GPRS/3G wireless communication system architecture;

FIG. 2A shows establishment of a conventional GTP user plane tunnel;

FIG. 2B shows establishment of a single GTP tunnel in accordance with the present invention;

FIG. 3 shows the system architecture evolution (SAE) of an LTE-based wireless communication system;

FIG. 4 shows a conventional tunnel protocol stack;

FIG. 5 shows an LTE GTP protocol stack in accordance with the present invention;

FIG. 6 is a flow diagram of a conventional tunnel establishment procedure;

FIG. 7 is a flow diagram of an LTE single GTP tunnel establishment (LTE attach) procedure in accordance with the present invention;

FIG. 8 shows a GTP intra-eNode intra-MME RA update in accordance with the present invention;

FIG. 9 is a flow diagram of a process for intra-MME RA update in accordance with the present invention;

FIG. 10 shows an inter-MME RA update for an LTE GTP-based system in accordance with the present invention; and

FIGS. 11A and 11B, taken together, are a flow diagram of a process for inter-MME RA update in accordance with the present invention.

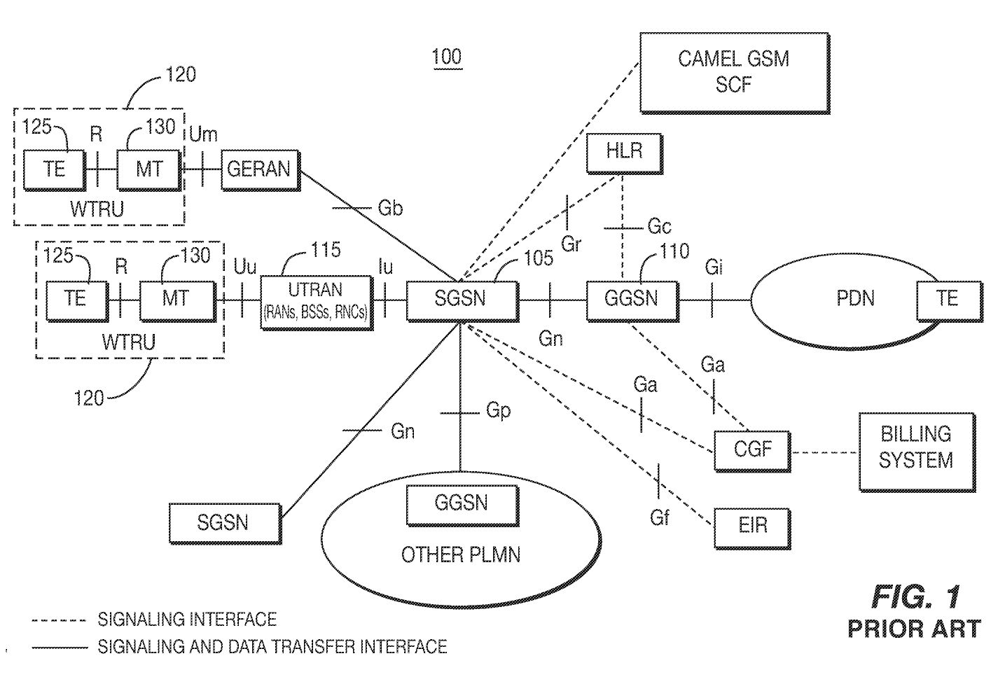

### DETAILED DESCRIPTION OF THE PREFERRED EMBODIMENTS

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

The features of the present invention may be incorporated into an integrated circuit (IC) or be configured in a circuit comprising a multitude of interconnecting components.

In accordance with the present invention, the mobility in GPRS, (3G or beyond), systems is facilitated by anchoring the IP session at the home GGSN and allowing for multi-level mobility, and by supporting existing MM protocols for non-IP traffic/services provided by the SGSN.

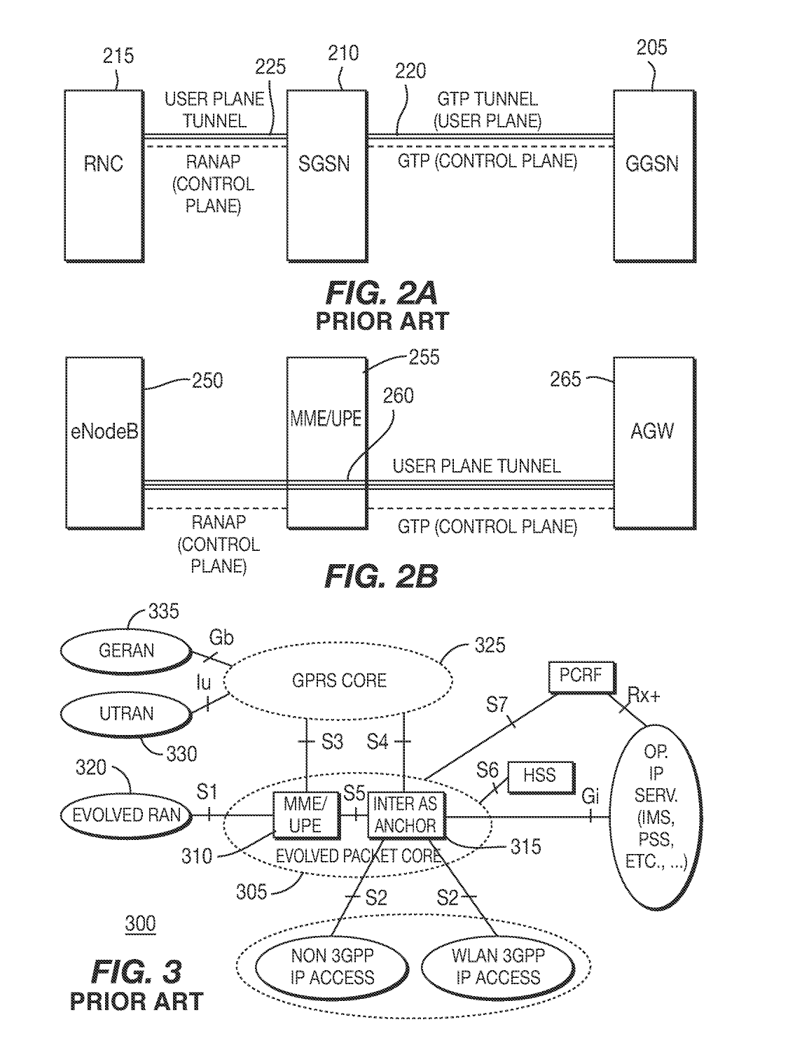

FIG. 2B shows a single user-plane tunnel approach in accordance with the present invention. A single user plane tunnel 260 is used to reduce the delay and processing power of an MME/UPE 255. In the two-tunnel approach shown in FIG. 2A, the SGSN 210 terminates both the GTP tunnel 220 and a user plane tunnel 225 to the RNC 215, which means that the SGSN 210 decodes the packets traveling in both directions and translates them into the different protocol formats of the two tunnels 220 and 225. In a single tunnel approach shown in FIG. 2B, the MME/UPE 255 only establishes a tunnel between the AGW 265 and the eNodeB 250 via two separate interfaces/protocols, (RANAP-C and GTP-C). In the single tunnel approach, the MME/UPE 255 is not involved in the user plane traffic. Thus, the user traffic passes through the MME/UPE 255 unchanged, (i.e., unaltered), in both directions. Only the eNodeB 250 and the AGW 265 are allowed to perform/act on the user plane traffic. The MME/UPE 255 only manages the control traffic, including MM, RAU, and the like, associated with the user and its IP based traffic. The MME/UPE 255 connects an eNodeB 250 and an AGW 265 using a GTP control plane to communicate with the AGW 265 and a RANAP control plane to communicate with the eNodeB 250. When a handoff occurs between eNodeBs, the MME/UPE 255 is responsible for providing the AGW 265 with the new eNodeB TEID information and the establishment of the single tunnel 260.

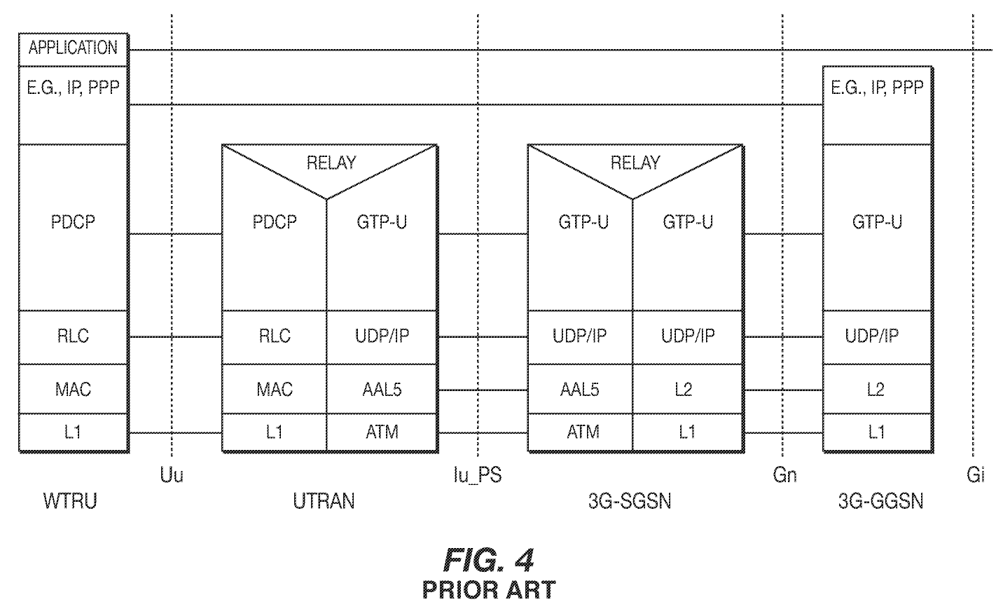

FIG. 4 shows a prior art tunnel protocol stack according to existing GPRS protocol. A GTP-U tunnel transfers, (i.e., tunnels), user data between a UTRAN (which includes RANs, BSSs and RNCs) and a 3G-SGSN, and between the 3G-SGSN and a 3G-GGSN.

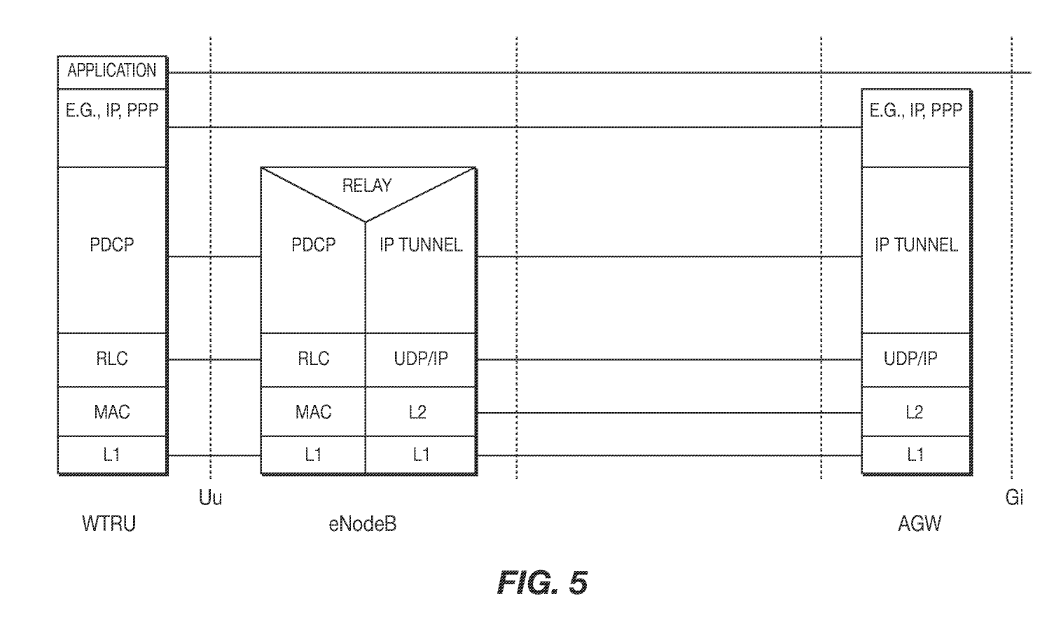

FIG. 5 shows tunnel protocol stack in accordance with the present invention, in which the user plane tunnel is established between an eNodeB and an AGW. The IP Tunnel shown in FIG. 5 can be GTP-based or any generic IP-Tunnel. In a preferred embodiment, the GTP-U tunnel is used as an IP tunnel.

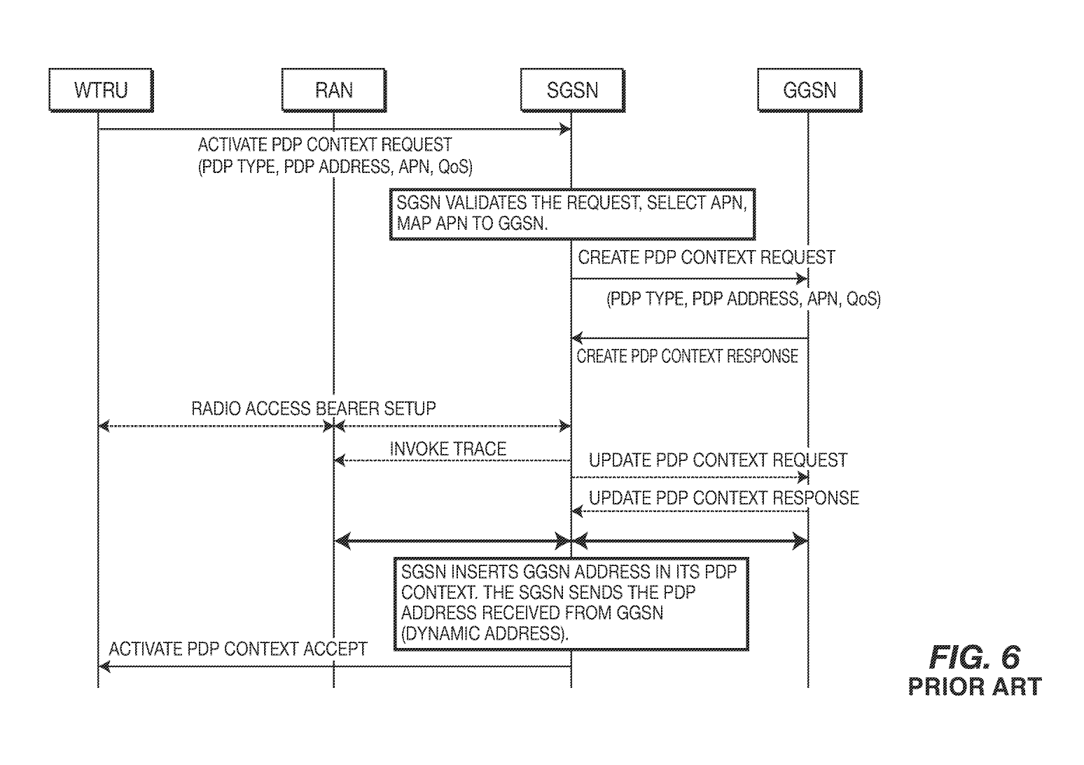

FIG. 6 is a conventional signaling diagram of a process for single tunnel establishment. The single tunnel functionality reduces the delay and processing power at the SGSN by reducing the need for protocol translation between the RNC and GGSN interfaces, and by enabling direct user plane tunnel between the RAN/RNC and the GGSN within the packet switched (PS) domain. However, the single tunnel approach will not eliminate the need for the SGSN to manage control traffic for IP-based traffic. The SGSN is still needed for the control plane signalling, MM and call/session management, and the SGSN makes a decision as to whether to establish a single tunnel or establish dual tunnels.

In the case of a single tunnel, the SGSN should connect the RAN/RNC TEID and the GGSN TEID for user plane by informing each end point of the tunnel of the corresponding TEID of the other end point, (i.e., informing the GGSN of the RNC TEID and informing the RNC of the GGSN TEID). In the case of a handoff between RNCs, the SGSN is responsible for updating and providing the GGSN with new RNC TEID information and the establishment of the single tunnel.

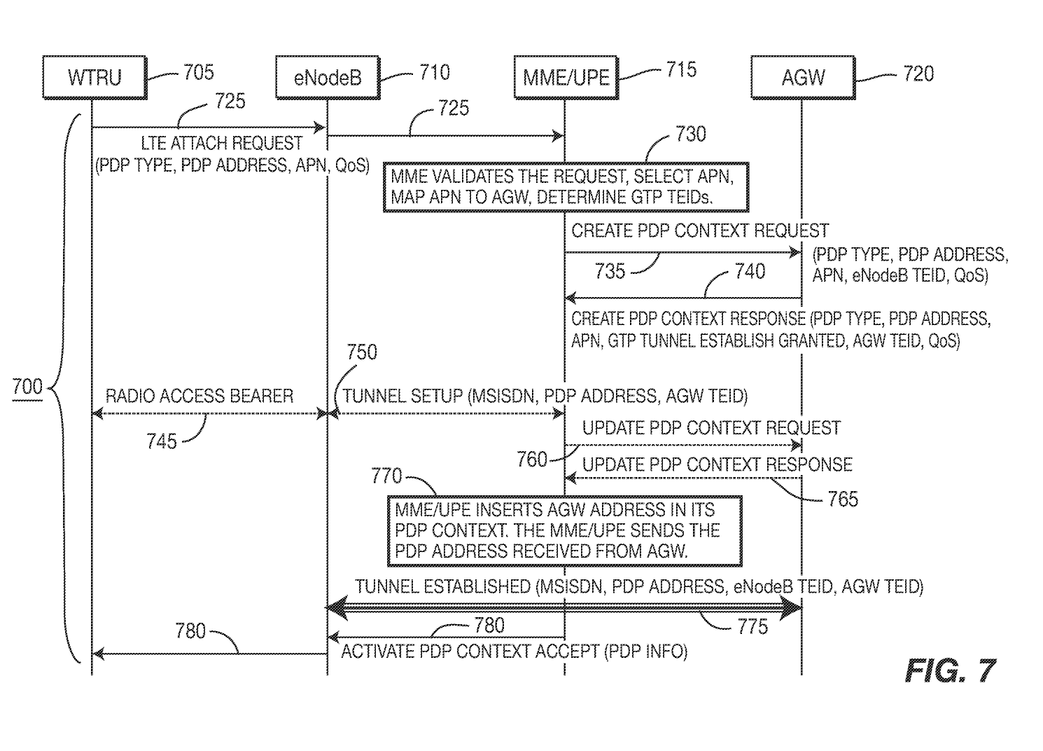

FIG. 7 shows an LTE single GTP tunnel establishment (LTE attach) procedure 700, (packet data protocol (PDP) context activation), which is implemented in a wireless communication system including a WTRU 705, an eNodeB 710, an MME/JPE 715 and an AGW 720 in accordance with the present invention. The WTRU 705 sends an LTE attach request message to the eNodeB 710 and the MME/UPE 715 that includes PDP type, PDP address, APN, quality of service (QoS) data and the like (step 725). The MME of the MME/UPE 715 validates the LTE attach request, selects an APN, and maps the APN to the AGW 720 (step 730). The MME/UPE 715 determines if a single tunnel is supported and/or requested, and notes the existence of GTP TEIDs (step 730). The MME/UPE 715 creates a PDP context request that includes PDP Type, PDP Address, APN, an eNodeB TEID, QoS and the like (step 735). The AGW 720 creates a PDP context response that includes PDP Type, PDP Address, APN, an indicator that the establishment of the GTP tunnel is granted, AGW TEID, QoS and the like (step 740). The WTRU 705 and the eNodeB 710 establish a radio access bearer (RAB) (step 745). In step 750, the MME/UPE 715 and the eNodeB 710 exchange tunnel setup signaling that includes a mobile station international subscriber directory number (MSISDN), a PDP address and an AGW TEID, and the MME/UPE 715 sends tunnel establishment information to the eNodeB 710 after receiving an indication of acceptance from the AGW 720 to establish the tunnel. The MME/UPE 715 sends an update PDP context request to the AGW 720 (step 760) to establish the new tunnel by informing the AGW 720 of the AGW TEID associated with the request, and the AGW 720 sends an update PDP context response to the MME/UPE 715 (step 765) confirming/rejecting the establishment of the tunnel and the associated attributes, (RNC TEID, PDP type, PDP address, user ID, and the like). The MME/UPE 715 inserts the AGW address in its PDP context, sends the PDP address received from the AGW 720 (step 770) and prepares for the response to be sent down to the WTRU 705. Thus, if necessary, the MME/UPE 715 updates the PDP context in the AGW 720 to reflect any changes in the QoS attributes resulting from the RAB establishment of step 745. Tunnel establishing signaling is exchanged between the eNodeB 710 and the AGW 720 including the MSISDN, PDP address, eNodeB TEID and AGW TEID (step 775). The MME/UPE 715 sends an activate PDP context accept signal to the WTRU 705 that indicates the presence of a single tunnel (step 780).

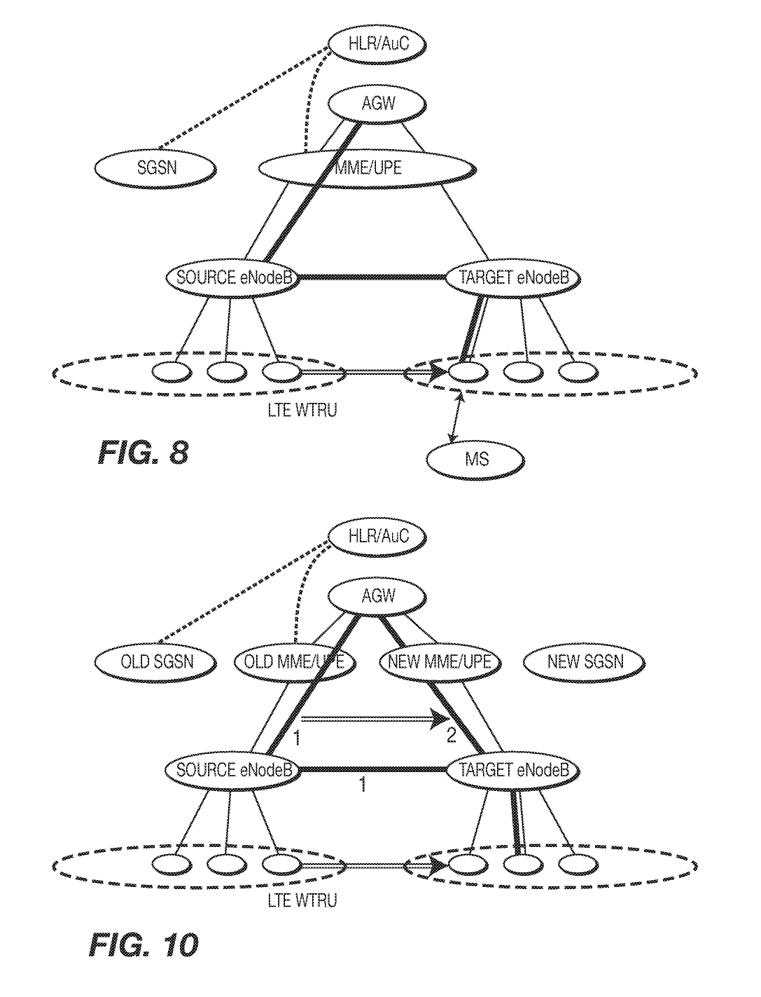

FIG. 8 shows a GTP intra-eNode intra-MME RA update in accordance with the present invention.

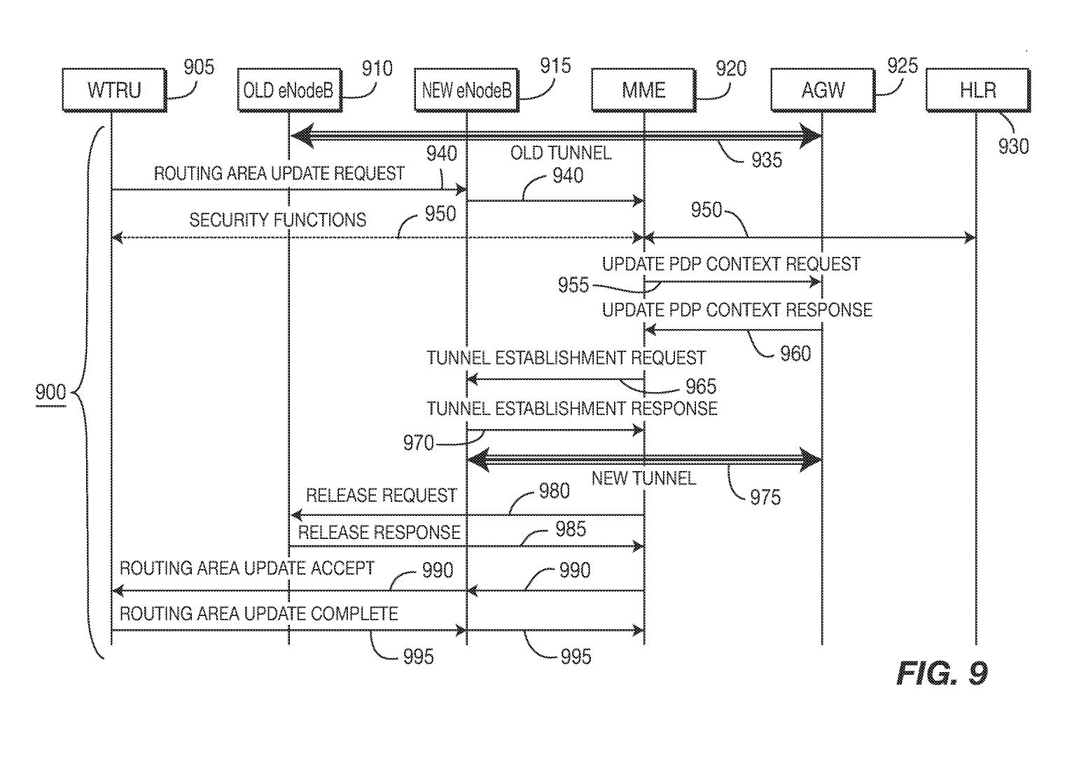

FIG. 9 shows a GTP intra-eNodeB intra-MME routing area update procedure 900, which is implemented in a wireless communication system including a WTRU 905, an old eNodeB 910, a new eNodeB 915, an MME 920, an AGW 925 and a home location register (HLR) 930 in accordance with the present invention.

Still referring to FIG. 9, an old tunnel is established between the old eNodeB 910 and the AGW 925 (step 935). The WTRU 905 sends a routing area update (EAU) request, which may include a packet temporary mobile subscriber identity (P-TMSI), old routing area identification (RAI), old P-TMSI signature, an update type and the like, to the new eNodeB 915 and the MME 920 (step 940). The update type indicates whether or not the routing area update is periodic. Security functions are then established between the WTRU 905, the MME 920 and the HLR 930 (step 950). The MME 920 sends an update PDP context request to the AGW 925 (step 955). The AGW 925 then sends an update PDP context response to the MME 920 (step 960). The MME 920 sends a tunnel establishment request to the new eNodeB 915 (step 965). In step 955, the MME 920 establishes the new tunnel between the AGW 925 and the new eNodeB 915 by sending the TEID of the new eNodeB 915 to the AGW 925 in the update PDP context request of step 955. If the request is granted, the AGW 925 confirms the request back to the MME 920 in step 960. In step 965, the MME 920 establishes the other end of the tunnel to the new eNodeB 915 by sending the TEID of the AGW 925 to the new eNodeB 915 via the tunnel establishment request message. In step 970, the new eNodeB 915 acknowledges the request and indicates the operation success to the MME 920 by sending a tunnel establishment response message. Now, a new tunnel is established in step 975.

Optionally, there may be additional update PDP context requests depending on the final set of QoS attributes. The new eNodeB 915 then sends a tunnel establishment response to the MME 920 (step 970). A new tunnel between the new eNodeB 915 and the AGW 925 is then established (step 975). Upon the successful establishment of the new tunnel, the MME 920 releases the old tunnel by sending a release request to the old eNodeB 910 in step 980. A release response is sent from the old eNodeB to the MME 920 (step 985). A routing area update accept is sent from the MME 920 to the new eNodeB 915 and the WTRU 905 (step 990). A routing area update complete message is then sent from the WTRU 905 to the new eNodeB 915 and the MME 920 (step 995).

FIG. 10 shows an inter-MME RA update for an LTE GTP-based system in accordance with the present invention.

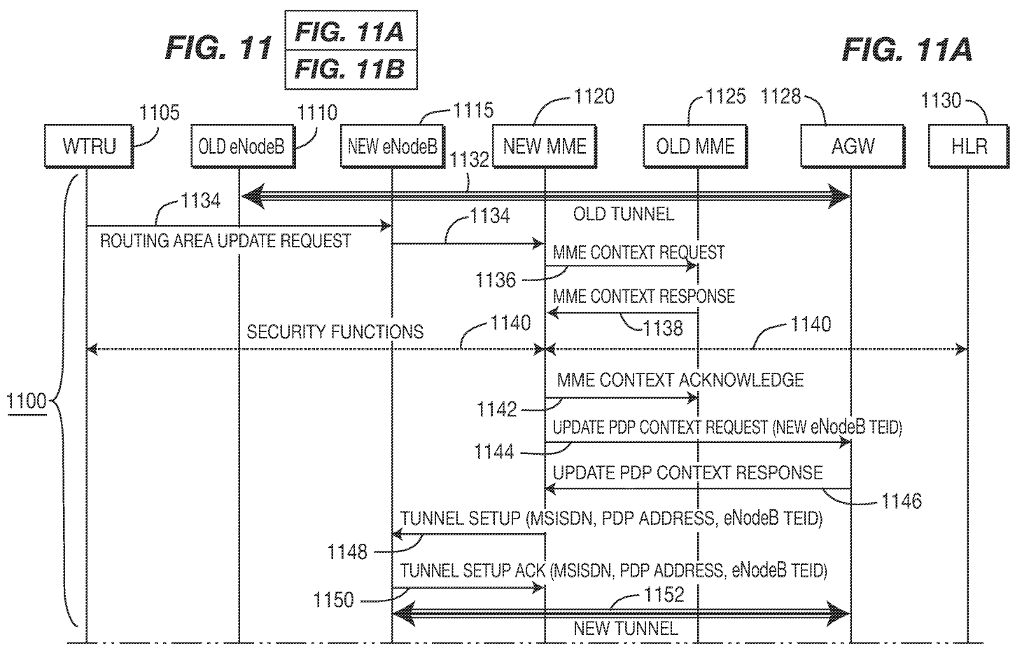

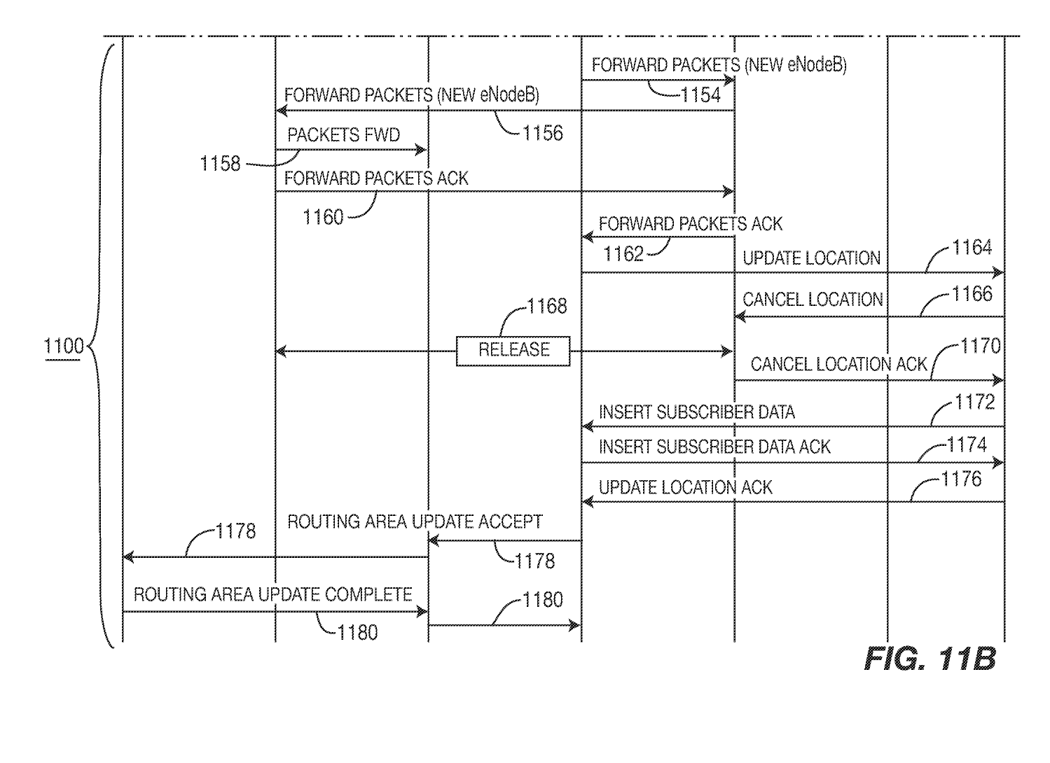

FIGS. 11A and 11B, taken together, show an LTE GTP intre-MME routing area update procedure 1100, which is implemented in a wireless communication system including a WTRU 1105, an old eNodeB 1110, a new eNodeB 1115, a new MME 1120, an old MME 1125, an AGW 1128 and an HLR 1130 in accordance with the present invention.

Referring to FIG. 11A, an old tunnel is established between the old eNodeB 1110 and the AGW 1128 (step 1132). The WTRU 1105 sends a routing area update request, which may include a P-TMSI, old RAI, old P-TMSI signature, an update type and the like, to the new eNodeB 1115 and the new MME 1120 (step 1134). The update type indicates whether or not the routing area update is periodic. The new MME 1120 sends an MME context request to the old MME 1125 (step 1136). The old MME 1125 sends an MME context response to the new MME 1120 (step 1138). Security functions are then established between the WTRU 1105, the new MME 1120 and the HLR 1130 (step 1140). The new MME 1120 sends an MME context acknowledge message to the old MME 1125 (step 1142) and sends an update PDP context request to the AGW 1128 (step 1144) which indicates a single tunnel and the TEID of the new eNodeB 1115. The AGW 1128 then sends an update PDP context response to the new MME 1120 (step 1146). The new MME 1120 sends a tunnel setup message to the new eNodeB 1115 which indicates the MSISDN, PDP address and the eNodeB TEID (step 1148). The new eNodeB 1115 then sends a tunnel setup acknowledgement message to the new MME 1120 (step 1150). A new tunnel between the new eNodeB 1115 and the AGW 1128 is then established (step 1152).

In the case of pending traffic in the system using the old tunnel, the traffic is forwarded from the old eNodeB 1110 to the new eNodeB 1115 for service continuity. Referring to FIG. 7B, after the new tunnel is established, forward packets are sent from the new MME 1120 to the old MME 1125 (step 1154). In step 1156, forward packets are sent from the old MME 1125 to the old eNodeB 1110. In step 1158, packets are forwarded from the old eNodeB 1110 to the new eNodeB 1115. In step 1160, the old eNodeB 1110 sends a forward packets acknowledgement message to the old MME 1125. In step 1162, the old MME 1125 sends a forward packets acknowledgement message to the new MME 1120. In step 1164, the new MME 1120 sends an update location message to the HLR 1130. In step 1166, the HLR 1130 sends a cancel location message to the old MME 1125. In step 1168, release signaling, (e.g., a release request message and a release response message), is exchanged between the old eNodeB 1110 and the old MME 1125. In step 1170, a cancel location acknowledgement message is sent from the old MME 1125 to the HLR 1130. In step 1172, insert subscriber data is sent from the HLR 1130 to the new MME 1120. In step 1174, the new MME 1120 sends an insert subscriber data acknowledgement message to the HLR 1130. In step 1176, the HLR 1130 sends an update location acknowledgement message to the new MME 1120. In step 1178, the new MME 1120 sends a routing area update accept message to the new eNodeB 1115 and the WTRU 1105. In step 1180, the WTRU 1105 sends a routing area update complete message to the new eNodeB 1115 and the new MME 1120.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method of establishing a single tunnel for a wireless transmit/receive unit (WTRU) in a wireless communication system including an evolved Node-B (eNodeB), a mobility management entity (MME) and an access gateway (AGW), the method comprising:
(a) the WTRU sending a long term evolution (LTE) attach request message to the MME via the eNodeB;
(b) the MME sending a create PDP context request message to the AGW, the create PDP context request message including a PDP address and a tunnel endpoint identity (TEID) of the eNodeB; and
(c) establishing a single tunnel between the AGW and the eNodeB.

2. The method of claim 1 further comprising:
the MME determining whether a single tunnel is supported, whereby the AGW includes the single tunnel request in the create PDP context request message only if a single tunnel is supported.

3. The method of claim 1 wherein step (c) further comprises:
(c1) the AGW sending a create PDP context response message to the MME in response to receiving the create PDP context request message, the create PDP context response message including a PDP address and a TEID of the AGW;
(c2) the MME receiving the create PDP context response message and exchanging tunnel setup information with the eNodeB; and
(c3) the MME inserting the address of the AGW in its PDP context and sending the PDP address received from the AGW to the eNodeB, whereby the single tunnel between the MME and the eNodeB is established.

4. A wireless communication system comprising:
an evolved Node-B (eNodeB);
a mobility management entity (MME);
an access gateway (AGW); and
a wireless transmit/receive unit (WTRU) configured to send a long term evolution (LTE) attach request message to the MME via the eNodeB, receive a create PDP context request message including a PDP address and a TEID of the AGW sent by the MME, and to establish a single tunnel between the AGW and the eNodeB.

5. The system of claim 4 wherein the AGW determines whether a single tunnel is supported, whereby the AGW includes the single tunnel request in the create PDP context request message only if a single tunnel is supported.

6. The system of claim 4 wherein the AGW sends a create PDP context response message to the MME in response to receiving the create PDP context request message, the create PDP context response message including a PDP address and a TEID of the AGW.

7. The system of claim 6 wherein the AGW receives the create PDP context response message and exchanges tunnel setup information with the eNodeB, and the MME inserts the address of the AGW in its PDP context and sends the PDP address received from the AGW to the eNodeB, whereby the single tunnel between the AGW and the eNodeB is established.

8. A method of performing a routing area update procedure for a wireless transmit/receive unit (WTRU) in a wireless communication system including a first evolved Node-B (eNodeB), a second eNodeB, a mobility management entity (MME) and an access gateway (AGW), wherein a first tunnel is established between the first eNodeB and the AGW, the method comprising:
the WTRU sending a routing area update request message to the second eNodeB and the MME;
the MME sending an update packet data protocol (PDP) context request message to the AGW;
the AGW sending an update PDP context response message to the MME;
the MME sending a tunnel establishment request message to the second eNodeB;
the second eNodeB sending a tunnel establishment response message to the MME; and
establishing a second tunnel between the second eNodeB and the AGW.

9. The method of claim 8 further comprising:
the MME sending a release request to the first eNodeB;
the first eNodeB sending a release response to the MME;
the MME sending a routing area update accept message to the WTRU; and
the WTRU sending a routing area update complete message to the MME.

10. A method of performing a routing area update procedure for a wireless transmit/receive unit (WTRU) in a wireless communication system including a first a first evolved Node-B (eNodeB), a second eNodeB, a first a mobility management entity (MME), a second MME and an access gateway (AGW), wherein a first tunnel is established between the first eNodeB and the AGW, the method comprising:
the WTRU sending a routing area update request to the second RNC and the first SGSN;
the first MME sending an MME context request message to the second MME;
the second MME sending an MME context response message to the first MME;
the first MME sending an update packet data protocol (PDP) context request to the AGW;
the AGW sending an update PDP context response to the first MME;
the first MME sending a tunnel setup message to the second eNodeB;
the second eNodeB sending a tunnel setup acknowledgement message to the first MME; and
establishing a second tunnel between the second eNodeB and the AGW.
